(19) United States
(12) Patent Application Publication
(10) Pub. No.: US 2020/0410373 A1
(43) Pub. Date: Dec. 31, 2020

(54) PREDICTIVE ANALYTIC METHOD FOR PATTERN AND TREND RECOGNITION IN DATASETS

(71) Applicant: Mohamad Zaim BIN AWANG PON, Cyberjaya (MY)

(72) Inventor: Mohamad Zaim BIN AWANG PON, Cyberjaya (MY)

(21) Appl. No.: 16/908,499

(22) Filed: Jun. 22, 2020

Related U.S. Application Data
(60) Provisional application No. 62/867,824, filed on Jun. 27, 2019.

(51) Int. Cl. G06N 5/04; G06F 16/22; G06N 20/00

(52) U.S. Cl. CPC G06N 5/04; G06N 20/00; G06F 16/2264

(57) ABSTRACT

A computer-implemented method for predicting output values in a multidimensional dataset comprising the steps of arranging a multidimensional dataset in a hierarchical order to a two-dimensional order; computing randomness of different permutations of variables; reordering the hierarchical order based on the randomness; computing contribution of each variable to an output; interpolating or extrapolating contribution values of each variable via mapping technique; and determining a predictive value for any given input by summing up the impact of each variable determined previously.

### FIELD OF INVENTION

The present invention relates to the field of machine learning. More particularly, the present invention relates to a predictive analytic method in datasets.

### BACKGROUND OF INVENTION

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Predictive analytics is an area of data mining that involves extraction of information from data and using the information to predict patterns and trends. Predictive analytics is commonly used in various industry sectors such as retail, healthcare, oil and gas as well as manufacturing. Predictive analytics uses data, statistical algorithms and machine learning techniques to analyse current data and identify the future output.

The current state of the art in machine learning is artificial neural network. Relationship between input variables and the output variable is established by combining many different linear relationships between the input parameters and the output. Another way to describe this, is the process akin to massive linear regression operations, with solutions commonly reached by the method known as backpropagation. Four major limitations with the current state of the technology to be addressed by the present invention are discussed below.

Firstly, the current state of the art does not capture the overall trend of the dataset, thereby making it difficult for a user to explain the results. The output is determined by combining linear operations instead of interpolating the trend within the dataset. In general, interpolation of the trend is only practical with two or three variables but started to fail with more due to the complexity of solving many variables in the linear operations. In other words, there are commonly more variables than equations to solve. Therefore, correct interpolation of trend is not possible with the current state of the art for a multidimensional problem. Current artificial neural network uses available data only and no solution space is provided where data is non-existent.

Correspondingly, other machine learning method creates branches of decision tree based only on existing data as well. Hence, gaps in the data are not modelled explicitly. Accordingly, neural network often needs re-training when new data is introduced. With no overall trend identified, the current methodology does not lend itself to easily explainable artificial intelligence method. The model does not explicitly model the in-between data whilst a user is unable to see the big picture of the solution space. The current approach is also very dependent on a significant amount of data available.

Secondly, the current state of the technology with the neural network only models existing data, and the multiple linear relationships are not being held by an overall trend. Hence, the predictive analytics for the space between the data is highly dependent on available data. The symptom of the absence of an overall trend is exemplified by artificial neural network method whereby an iteration process is used to reach a solution.

Thirdly, the current state of deep learning requires hyperparameter tuning. The accuracy of the model and end results often depends on hyperparameter tuning. Much of the hyperparameter tuning with deep learning is required for the iteration process to obtain solutions for example, gradient descent and back propagation.

Fourthly, the current state of deep learning requires modelling the architecture, such as several hidden layers and neurons. Too few but too wide layers often lead to overfitting while too many but too narrow leads to overgeneralization. Often, iteration is required to obtain the optimum hyperparameters.

Therefore, there is a need method for predictive analytics which addresses the abovementioned drawbacks.

### SUMMARY OF INVENTION

A computer-implemented method for predicting output values in a multidimensional dataset (100) comprising the steps of arranging a multidimensional dataset in a hierarchical order to a two-dimensional order; computing randomness of different permutations of variables; reordering the hierarchical order based on the randomness; computing contribution of each variable to an output; interpolating or extrapolating contribution values of each variable via mapping technique; and determining a predictive value for any given input by summing up the impact of each variable determined previously.

Preferably, the present invention provides a method to simplify a multidimensional problem into a two-dimensional problem, whereby one dimension on the x-axis is the output and the other dimension on the y-axis is the combination of all variables.

In a further aspect, the present invention solves the issue of incomplete data in predictive analytics by extracting the net trend and impact of each variable, even where there is a significant gap in data.

Preferably, there are at least two possible ways for computing randomness of different permutation of variables which includes, linear extrapolation of the next location of the output data point from the last two data points within the two-dimensional hierarchy and comparing it to actual data. The deviation is summed up for each variable. The variable with the highest deviation is considered the most random variable and vice versa.

Preferably, another possible way of computing randomness of different permutation of variable includes, includes pairing each variable against the other in a three-dimensional space, and creating the best fit surface for the pair. The most random pair would have the most significant deviation from the best fit surface.

Preferably, the step of computing the contribution of each variable to the output includes averaging out variation on lower-ranking variables to the variable of interest, whilst not including the previously determined impact of higher ranking variables to the variable of interest to allow the net impact of the variable of interest to be determined.

Preferably, the step of interpolating the contribution value is done by rearranging the data in a two-dimensional map, wherein the bins of the variable itself are in the y-axis of the map, and the values of the variable and lower ranking variables values are mapped in the x-axis. Preferably, the interpolation of the mapping can be done via any method such as kriging.

Additional aspects, applications and advantages will become apparent given the following description and associated figures.

### BRIEF DESCRIPTION OF DRAWINGS

FIG. 1 shows a flowchart of a predictive analytic method for pattern and trend recognition in datasets (100) in accordance with an embodiment of the present invention.

FIG. 2A shows a diagram of a hierarchical structure of variables of the method (100) of FIG. 1 in accordance with an embodiment of the present invention.

FIG. 2B shows a diagram of the hierarchical structure of the variables and the impact of arranging the variables with and without the right ranking according to the method (100) of FIG. 1.

FIG. 3A shows a diagram of one of the possible methods for computing randomness within the hierarchy using one variable at a time in accordance with an embodiment of the present invention.

FIG. 3B shows a diagram of another possible methods for computing randomness within the hierarchy using a pair of variables at a time in accordance with an embodiment of the present invention.

FIG. 4 illustrates an actual data and an averaged data for determination of variable trend in accordance with an embodiment of the present invention.

FIG. 5 illustrates a map interpolation of the method (100) of FIG. 1.

### DETAILED DESCRIPTION

Exemplary embodiments are described herein. However, the extent that the following description is specific to a particular embodiment, this is intended to be for exemplary purposes only and simply describes the exemplary embodiments.

Accordingly, the invention is not limited to the specific embodiments described below, but rather, it includes all alternatives, modifications, and equivalents falling within the true spirit and scope of appended claims.

The present technological advancement may be described and implemented in the general context of a system and computer methods to be executed by a computer which includes but not limited to mobile technology. Such computer-executable instructions may include programs, routines, objects, components, data structures, and computer software technologies that can be used to perform particular tasks and process abstract data types. Software implementations of the present technological advancement may be coded in different languages for application in a variety of computing platforms and environments. It will be appreciated that the scope and underlying principles of the present invention are not limited to any particular computer software technology.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present technological advancement.

Referring now to the drawings, embodiments of the present technological advancement will be described. The present technological advancement can be implemented in numerous ways, including, for example, as a system including a computer processing system, a method including a computer implemented method, an apparatus, a computer readable medium, a computer program product, a graphical user interface, a web portal, or a data structure tangibly fixed in a computer readable memory. Several embodiments of the present technological advancements are discussed below. The appended drawings illustrate only typical embodiments of the present technological advancement and therefore are not to be considered limiting of its scope and breadth.

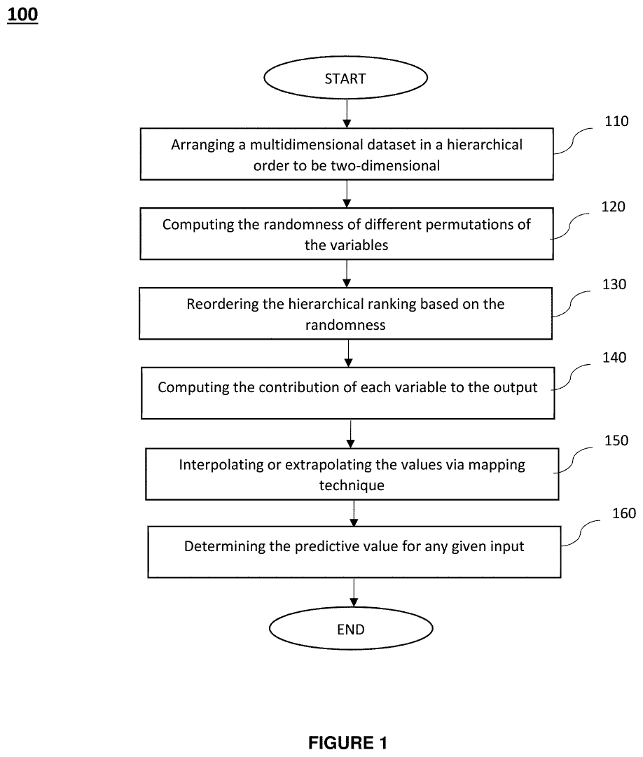

FIG. 1 is a flowchart of a predictive analytic method for pattern and trend recognition in datasets (100) according to an embodiment of the present invention.

Initially, a multidimensional dataset is arranged in a hierarchical order into a two-dimensional dataset as in step 110. The dataset consists of a mixture of numerical and non-numerical data. The non-numerical data may not be included in the machine learning process or if it influences the output, encoded to numerical data. A non-technical analogy for a hierarchy is the structure of the family. If the parents are at the top of the family hierarchy, the family is considered as in “order”. In this case, family member is akin to a variable in the dataset with the dataset akin to the family. However, for example, if the one-year old child is the top in the family hierarchy, the family is in chaos. Similarly, for a dataset, there are variables that have the most impact and needs to be at the top of the hierarchy. At this initial stage, an arbitrary order is assumed for the variables.

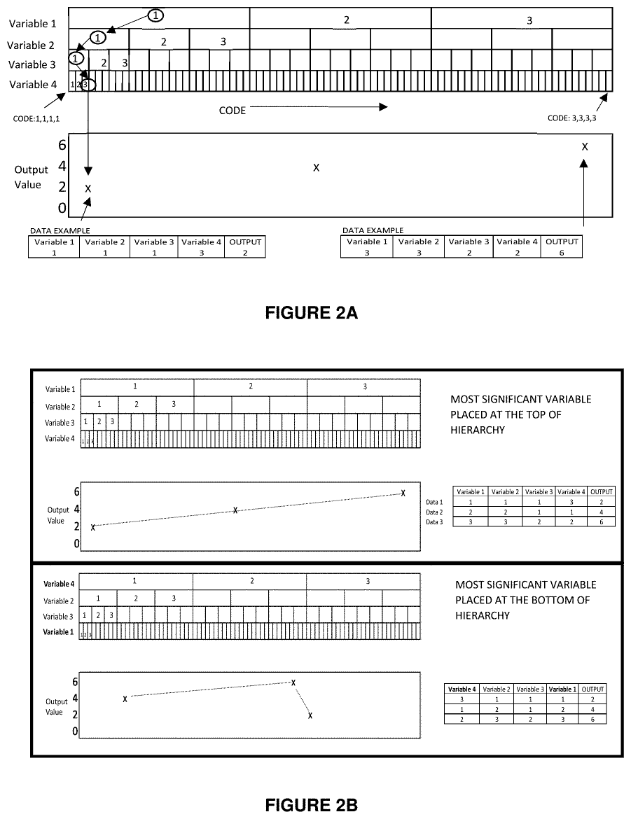

FIG. 2A illustrates a diagram of a hierarchical structure of the variables of the method of FIG. 1 according to an embodiment of the present invention. It is shown that the problem is reduced to a two-dimensional problem, even with a four-dimensional problem or more, for a more manageable for predictive analytics. This is also done without sacrificing any low-ranking variables. Preferably, the variables are binned accordingly based on accuracy desired, complexity of the data, and available computing power. The higher the resolution, the more accurate the prediction is, but also with more intensive computing power. Without binning, there is an infinite number of combinations to be considered. The data can also be normalized for ease of processing.

FIG. 2B shows a diagram of the hierarchical structure of the variables and the impact of arranging the variables with and without the right ranking according to the method (100) of FIG. 1. The figure illustrates the importance of ranking variables by analysing the impact of ranking noisy variable at the top hierarchy versus the impact of ranking noisy variable at the bottom hierarchy. According to data in table of FIG. 2B, the ground truth trend of the data is linear, with Variable 1 having the most impact on the linear trend, while Variable 4 is the most random variable or referred as noisy variable. If the most random variable, or in this example, Variable 4 is put at the top of the hierarchy, the ensuing trend will also be chaotic and less predictable as oppose to linear.

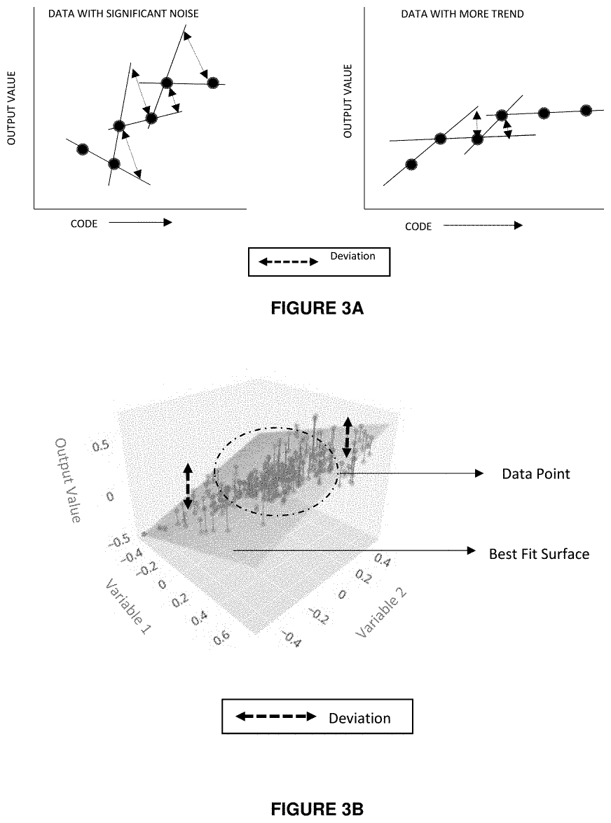

Therefore, in order to rank the variables, randomness of different permutations of variables is computed as in step 120. The process for determining the ranking of variables involves determining the randomness score of the permutation of the order of variables. Several approach can be undertaken to calculate the randomness score of each permutation. Typically, in order to determine to most optimum variable order in the hierarchy, many possible permutations need to be computed, whichever approach is chosen. Two approach are illustrated in FIGS. 3A and 3B, wherein each permutation of the ranking is tested.

FIG. 3A shows a diagram of one of the possible methods for computing randomness score within the hierarchy using one variable at a time in accordance with an embodiment of the present invention. In this approach, linear extrapolation of the next location of the output data point are made from the last two data points. The linearly predicted data point is compared to the actual data point. The deviation is then summed up for each variable, wherein the higher the deviation, the more random it is. Furthermore, the total distance for each data point in the variables in the permutation is compared to other permutations. Generally, the permutation with the lowest random score has the most predictable trend, hence is the ideal order in the hierarchy.

FIG. 3B is a diagram of another possible methods for computing randomness score within the hierarchy using a pair of variables at a time in accordance with an embodiment of the present invention. The variable with the highest deviation is considered the most random variable and vice versa. In this approach, each variable is paired, wherein one variable is on x-axis, another variable in y-axis, while output data value in the z-axis. The best fit surface for the pair is then created and the most random pair would have the most significant deviation from the best fit surface. The deviation is summed up for each variable pair. Accordingly, the higher the number, the more random the variable is. The total distance for each data point in the variables in the permutation is compared to other permutations. Again, the permutation with the lowest random score usually has the most predictable trend and that is the ideal order in the hierarchy.

The approach in FIG. 3B is generally more robust than the approach shown in FIG. 3A as it takes into account the dependency between any two variables.

Thereon, once the permutation with the maximum orderliness or least randomness has been determined, the hierarchical ranking is reordered accordingly as in step 130. It is critical to have the best order of ranking possible on the ground that, if the most noisy or random variable is set at the top of the hierarchy, the output may be so erratic such that the predictability is affected negatively. By referring to FIG. 2B, wherein the most impactful variable, Variable 1, needs to be at the top of the hierarchy. A non-impactful variable that is mainly noise, if made to be the most important variable will ruin the actual linear trend or order of the data.

Next, contribution or impact of each variables to the output is computed as in step 140. The impact of variables is computed by averaging out variation on the lower-ranking variables to the variable of interest, whilst not including the previously determined impact of higher-ranking variables to the variable of interest to allow the net impact of the variable of interest to be determined.

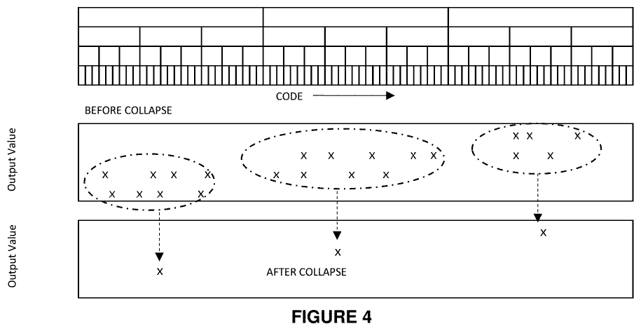

FIG. 4 illustrates an actual data and an averaged data for determination of variable trend in accordance with an embodiment of the present invention. It is shown that, the trend of each variables is captured, starting with the first-ranking variable. The trend of a lower-ranking variable is determined in a similar manner with the exception that the previously determined higher-ranking variable are extracted. The lower-ranking variable is a variable with the lower impact on the output, whereas the higher-ranking variable is a variable with higher impact on the output. With the variation of the lower-ranking variable is averaged out and the pre-determined higher-ranking variable is extracted out, the net trend of each variable is determined. The extraction of the higher impact of the higher-ranking variable is simplified since the impact of variable was previously determined and the variable was extracted from the actual data value, leaving the value of the lower-ranking variables. Accordingly, the impact of each variable is determined. This is important as the output from a combination of variables can only be determined once the net trend of each variable is determined.

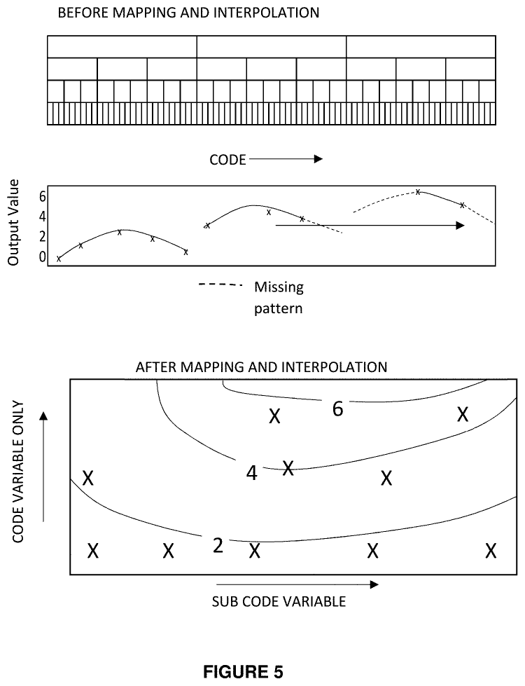

After the contribution of each variable is computed, the values are interpolated via mapping techniques as in step 150. FIG. 5 illustrates a map of interpolation method of FIG. 1, 2, 3A or 3B and 4. The interpolation for each variable value is achieved by rearranging the data in a two-dimensional map where the bins of the variable itself are in the y-axis of the map, and the values of the variable are mapped in the x-axis.

Preferably, the interpolation of the mapping can be done via any method such as kriging.

Finally, the predictive value for any combination of input variable is determined as in step 160. The predictive value of any combination of input variables is determined by summing up the impact of each variable determined previously. This impact may provide insight into a prediction problem in dataset by recognising the relationship between input and output variables being observed.

Advantageously, the present invention solves the issue of incomplete data in predictive analytics by extracting the net trend and impact of each variable, even where there is a significant gap in data. Quite often, the data doesn't vary monotonously. This presents a challenge in interpolation of extrapolation. Even in between available data, a repeating pattern may consist of both increasing and decreasing trend. The challenge of n-variables complexity is overcome by simplifying a multidimensional problem to a two-dimensional problem. The two-dimensional problem also addresses the predictive analytics challenge with complex trend of the data by two-dimensional mapping of the data. The mapping enables easy interpolation or extrapolation in the x-axis and y-axis directions in the map. This advanced interpolation methodology allows for prediction be made even with much less data than with neural network.

Additionally, the present invention is not dependent on iteration. Instead, it depends on interpolation or mapping the solution space to predict the output. Therefore, no hyperparameter tuning is required. The present invention also requires no architecture modelling as it is not dependent on tensor or matrices operation to link the input to output.

In summary, the method (100) of the present invention does not utilize any neural network. Instead, it depends on simplifying the multidimensional problem into a two-dimensional problem, whereby one dimension on the x-axis is the output and the other dimension on the y-axis is the combination of all variables. Given that that the problem now is in two dimensional, it allows for much easier interpolation and extrapolation regardless of the number of variables. All the combinations of variables are captured with discrete bins within the desired minimum and maximum range regardless of whether data is available or not. It is worth noting that the discrete bins are necessary, otherwise there is an infinite number of combinations. Despite a significant number of variables, the two-dimensional approach allows for predictive analytics over the whole range of spectrum. In essence, the present invention puts the data in a two-dimensional space without sacrificing any data or variables, allowing capturing of the trend where data does not exist, as oppose to modelling available data only, the approach with artificial neural network.

From the foregoing, it would be appreciated that the present invention may be modified in light of the above teachings. It is therefore understood that, within the scope of the appended claims, the invention may be practiced otherwise than as specifically described.

1. A computer-implemented method for predicting output values in a multidimensional dataset comprises the step of:
(a) arranging a multidimensional dataset in a hierarchical order to a two-dimensional order;
(b) computing randomness of different permutations of variables;
(c) reordering the hierarchical order based on the randomness;
(d) computing contribution of each variable to an output;
(e) interpolating or extrapolating contribution values of each variable via mapping technique; and
(f) determining a predictive value for any given input by summing up the contribution of each variable to the output.

2. The method as claimed in claim 1, wherein the step of arranging the multidimensional dataset in a hierarchical order to a two-dimensional order with minimum to maximum range values for each variable segregated into discrete bins covering any available data and gap in the data.

3. The method of claim 1, wherein the step of computing the randomness of different permutations of variables includes determining the ideal hierarchy order of the variables.

4. The method as claimed in claim 3, wherein the step of computing the randomness of variable is performed by extrapolating a linear output data point from at least the last two data points and computing the deviation of the linear output data point from the linear trend of the prior data points, wherein lower deviation of the output data point from the linear trend of prior data points corresponds to lower randomness score.

5. The method as claimed in claim 3, wherein the step of computing the randomness of a pair combination of variables is performed by creating a best fit surface in three dimension and computing the deviation of the data point from that best fit surface, wherein lower deviation of a variable pair from the best fit surface corresponds to lower randomness score.

6. The method as claimed in claim 1, wherein the step of reordering the hierarchical order based on randomness is performed by such that the least random variable is set at the top of the hierarchy and the most random variable is set at the bottom of the hierarchy for optimum prediction accuracy.

7. The method as claimed in claim 1, wherein the step of computing contribution of each variable output is performed by averaging out variation on lower-ranking variables to the variable of interest, whilst not including the previously determined impact of higher ranking variables to the variable of interest to allow the net impact of the variable of interest to be determined.

8. The method as claimed in claim 1, wherein the step of interpolating or extrapolating contribution value of each variable is performed by breaking the series into segments and plotting the segment value in the y-axis with the range within a segment in the x-axis.
